(19) United States
(12) Patent Application Publication
(10) Pub. No.: US 2026/0227102 A1
(43) Pub. Date: Aug. 6, 2026

(54) BEARING SYSTEM FOR HVAC&R SYSTEM

(71) Applicant: Tyco Fire & Security GmbH, Neuhausen am Rheinfall (CH)

(72) Inventors: Bryson Lee Sheaffer, Mechanicsburg, PA (US); Paul William Snell, York, PA (US)

(21) Appl. No.: 19/153,925

(22) PCT Filed: Feb. 7, 2024
(86) PCT No.: PCT/US2024/014792

§ 371 Date: Aug. 5, 2025

Related U.S. Application Data
(60) Provisional application No. 63/443,921, filed on Feb. 7, 2023.

(51) Int. Cl. F25B 31/00; F16C 33/10

(52) U.S. Cl. CPC F25B 31/002; F16C 33/1025; F16C 2202/32; F25B 2500/16

(57) ABSTRACT

A heating, ventilation, air conditioning, and refrigeration (HVAC&R) system includes a compressor configured to circulate a working fluid along a working fluid circuit, a bearing disposed about a shaft of the compressor, and a fluid supply system configured to direct a portion of the working fluid from the working fluid circuit to the bearing, where the bearing is configured to discharge the portion of the working fluid toward the shaft.

### CROSS-REFERENCE TO RELATED APPLICATIONS

This application claims priority from and the benefit of U.S. Provisional Application No. 63/443,921, entitled “BEARING SYSTEM FOR HVAC&R SYSTEM,” filed Feb. 7, 2023, which is hereby incorporated by reference in its entirety for all purposes.

### BACKGROUND

This section is intended to introduce the reader to various aspects of art that may be related to various aspects of the present disclosure, which are described below. This discussion is believed to be helpful in providing the reader with background information to facilitate a better understanding of the various aspects of the present disclosure. Accordingly, it should be understood that these statements are to be read in this light, and not as admissions of prior art.

Chiller systems, or vapor compression systems, utilize a working fluid (e.g., a refrigerant) that changes phases between vapor, liquid, and combinations thereof in response to exposure to different temperatures and pressures within components of the chiller system. The chiller system may place the working fluid in a heat exchange relationship with a conditioning fluid (e.g., water) and may deliver the cooling fluid to conditioning equipment and/or a conditioned environment serviced by the chiller system. In such applications, the conditioning fluid may be directed through downstream equipment, such as air handlers, to condition other fluids, such as air in a building. The chiller system may include a compressor configured to pressurize the working fluid and circulate the working fluid through a working fluid circuit of the chiller system. In some applications, a shaft of the compressor may be driven in rotation by a motor in order to drive rotation of an impeller of the compressor that pressurizes the working fluid. Traditionally, the compressor includes bearings configured to facilitate rotation of the shaft. Unfortunately, existing bearings utilized with compressors may be complex, expensive, and/or may contribute to inefficiencies in operation of the chiller system.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, a heating, ventilation, air conditioning, and/or refrigeration (HVAC&R) system includes a compressor configured to circulate a working fluid along a working fluid circuit, a bearing disposed about a shaft of the compressor, and a fluid supply system configured to direct a portion of the working fluid from the working fluid circuit to the bearing, where the bearing is configured to discharge the portion of the working fluid toward the shaft.

In another embodiment, a heating, ventilation, air conditioning, and refrigeration (HVAC&R) system includes a working fluid circuit having a compressor, an evaporator, and a condenser, where the compressor is configured to circulate a working fluid along the working fluid circuit. The HVAC&R system also includes a bearing assembly of the compressor, where the bearing assembly is disposed about a shaft of the compressor, the bearing assembly includes a plurality of radial bearing segments arrayed about a circumference of the shaft, and each radial bearing segment of the plurality of radial bearing segments includes a porous material. The HVAC&R system further includes a fluid supply circuit extending from the working fluid circuit to the bearing assembly, where the fluid supply circuit is configured to direct a flow of the working fluid from the working fluid circuit to the bearing assembly.

In a further embodiment, a heating, ventilation, air conditioning, and refrigeration (HVAC&R) system includes a bearing configured to be disposed about a shaft of a compressor, where the bearing includes a porous material, and the bearing is configured to discharge a flow of fluid through the porous material and toward the shaft of the compressor. The HVAC&R system also includes a fluid supply system configured to direct the flow of fluid from a working fluid circuit of the HVAC&R system to the bearing, where the fluid supply system is configured to supply the flow of fluid to the bearing in a liquid phase, and the bearing is configured to discharge the flow of fluid toward the shaft in a vapor phase.

### DRAWINGS

Various aspects of this disclosure may be better understood upon reading the following detailed description and upon reference to the drawings in which:

FIG. 1 is a perspective view of an embodiment of a building that may utilize a heating, ventilating, air conditioning, and/or refrigeration (HVAC&R) system in a commercial setting, in accordance with an aspect of the present disclosure;

FIG. 2 is a perspective view of an embodiment of a vapor compression system, in accordance with an aspect of the present disclosure;

FIG. 3 is a schematic of an embodiment of a vapor compression system, in accordance with an aspect of the present disclosure;

FIG. 4 is a schematic of an embodiment of a vapor compression system, in accordance with an aspect of the present disclosure;

FIG. 5 is a cross-sectional side view of an embodiment of a compressor of a vapor compression system, illustrating a bearing system of the compressor, in accordance with an aspect of the present disclosure;

FIG. 6 is an axial view of a portion of an embodiment of a compressor including a bearing system for the compressor, in accordance with an aspect of the present disclosure

FIG. 7 is a schematic of an embodiment of a bearing component of a bearing system for a compressor, in accordance with an aspect of the present disclosure;

FIG. 8 a schematic of an embodiment of a vapor compression system including a fluid supply system and a bearing system for a compressor, in accordance with an aspect of the present disclosure;

FIG. 9 is a schematic of an embodiment of a vapor compression system including a fluid supply system and a bearing system for a compressor, in accordance with an aspect of the present disclosure;

FIG. 10 is a partial cross-sectional side view of an embodiment of a bearing of a bearing system for a compressor, in accordance with an aspect of the present disclosure; and

FIG. 11 is a partial cross-sectional side view of an embodiment of a bearing of a bearing system for a compressor, in accordance with an aspect of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As used herein, the terms “approximately,” “generally,” and “substantially,” and so forth, are intended to convey that the property value being described may be within a relatively small range of the property value, as those of ordinary skill would understand. For example, when a property value is described as being “approximately” equal to (or, for example, “substantially similar” to) a given value, this is intended to mean that the property value may be within +/−5%, within +/−4%, within +/−3%, within +/−2%, within +/−1%, or even closer, of the given value. Similarly, when a given feature is described as being “substantially parallel” to another feature, “generally perpendicular” to another feature, and so forth, this is intended to mean that the given feature is within +/−5%, within +/−4%, within +/−3%, within +/−2%, within +/−1%, or even closer, to having the described nature, such as being parallel to another feature, being perpendicular to another feature, and so forth. Further, it should be understood that mathematical terms, such as “planar,” “slope,” “perpendicular,” “parallel,” and so forth are intended to encompass features of surfaces or elements as understood to one of ordinary skill in the relevant art, and should not be rigidly interpreted as might be understood in the mathematical arts. For example, a “planar” surface is intended to encompass a surface that is machined, molded, or otherwise formed to be substantially flat or smooth (within related tolerances) using techniques and tools available to one of ordinary skill in the art. Similarly, a surface having a “slope” is intended to encompass a surface that is machined, molded, or otherwise formed to be oriented at an angle (e.g., incline) with respect to a point of reference using techniques and tools available to one of ordinary skill in the art.

Embodiments of the present disclosure relate to a heating, ventilation, air conditioning, and refrigeration (HVAC&R) system (e.g., a chiller) including a vapor compression system (e.g., vapor compression circuit) having a compressor. In operation, the compressor may pressurize a working fluid within the vapor compression system and direct the working fluid to a condenser (e.g., a first heat exchanger), which may cool and condense the working fluid. The condensed working fluid may be directed to an expansion device, which may reduce a pressure of the working fluid, further cooling the working fluid. From the expansion device, the cooled working fluid may be directed to an evaporator (e.g., a second heat exchanger), where the working fluid may be placed in a heat exchange relationship with a conditioning fluid to cool the conditioning fluid. The conditioning fluid may be circulated between the evaporator and a structure, such as a building, where the conditioning fluid is used to cool an air flow delivered to a conditioned space of the structure. In some embodiments, an air handling unit (AHU) of the HVAC&R system may receive the conditioning fluid from the chiller and utilize the conditioning fluid to cool the air flow delivered to the conditioned space. The conditioning fluid may then be returned to the evaporator to be cooled again.

In some embodiments, the compressor may include an impeller configured to rotate to enable pressurization of the working fluid and to direct the working fluid through the vapor compression system. For example, the impeller may be coupled to a shaft, and the shaft may be configured to rotate relative to a housing of the compressor to drive rotation of the impeller relative to the housing. Typically, the compressor includes one or more bearings configured to facilitate rotation of the shaft relative to the housing of the compressor. Unfortunately, existing bearings for compressors are susceptible to numerous drawbacks. For example, existing bearings may include a sleeve, roller elements, or other bearing surfaces that are lubricated by a dedicated lubricant, such as oil. The use of oil within the vapor compression system may degrade heat transfer efficiency between the working fluid circulated through the vapor compression system and other fluids, such as the conditioning fluid. Additionally, systems having oil lubricated bearings typically include complex subsystems, as well as oil return systems, to manage proper lubrication of the bearings. Magnetic bearings may also be utilized with compressors. However, magnetic bearings are complex, expensive, and utilize complicated control systems. Therefore, improved compressor bearings that are lower cost and enable more efficient operation of the vapor compression system are desired.

Accordingly, present embodiments are directed to a bearing system configured to enable and facilitate operation of a compressor in a vapor compression system with improved efficiency and at reduced costs. In particular, bearing systems described herein are configured to utilize a pressurized fluid, such as the working fluid (e.g., refrigerant) circulated through the vapor compression system, to support a load of the shaft of the compressor and enable rotation of the shaft within the housing of the compressor. The pressurized fluid may also function as a lubricant. To this end, the bearing system includes one or more bearings having porous bearing elements configured to receive the pressurized fluid. The pressurized fluid (e.g., liquid) may be directed through the porous bearing elements and may be discharged to contact the shaft within the housing. As the pressurized fluid is directed through and discharged from the porous bearing elements, the pressurized fluid may vaporize or “flash” to become a vapor or gas that contacts the shaft and forms a hydrostatic film about the shaft. In this way, the working fluid circulated through the vapor compression system to enable heat exchange with other fluids (e.g., a conditioning fluid supplied to a load) may also be utilized as a lubricant that enables desired operation of the compressor. Indeed, present embodiments enable incorporation of bearings within the compressor without utilizing a separate, dedicated lubricant, such as oil. Disclosed embodiments of the bearing system may also be implemented at reduced costs (e.g., manufacturing costs, operating costs, maintenance costs) compared to traditional bearings. Further, the techniques discussed herein enable incorporation and operation of bearing systems with compressors with simplified control schemes, improved reliability, and desirable monitoring.

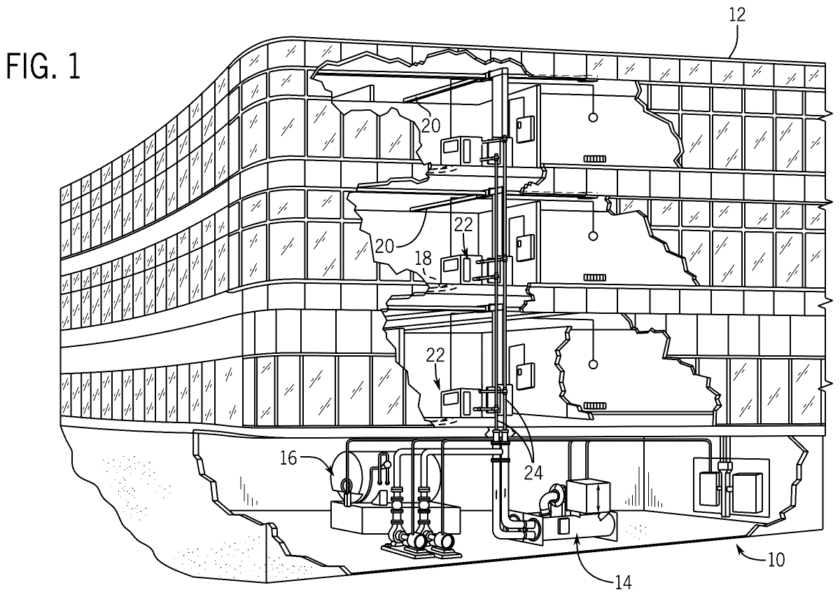

Turning now to the drawings, FIG. 1 is a perspective view of an embodiment of a heating, ventilating, air conditioning, and/or refrigeration (HVAC&R) system 10 in a building 12 for a typical commercial setting. The HVAC&R system may include a vapor compression system 14 to supply chilled liquid to cool the building 12 and a boiler 16 to supply warm liquid to heat the building 12. The vapor compression system 14, also referred to herein as a chiller, may circulate a working fluid (e.g., refrigerant) that is cooled by a cooling fluid (e.g., liquid such as water) in a condenser of the vapor compression system 14, and that is heated by a conditioning fluid (e.g., liquid, such as water) in an evaporator of the vapor compression system 14. The cooling fluid may be provided by a cooling tower which cools the cooling fluid via, for example, ambient air. The conditioning fluid, cooled by the working fluid as noted above, may be utilized to cool an air flow provided to conditioned spaces of the building 12.

The HVAC&R system 10 may also include an air distribution system which circulates air through the building 12. The air distribution system can also include an air return duct 18, an air supply duct 20, and/or an air handler 22. In some embodiments, the air handler 22 may include a heat exchanger that is connected to the boiler 16 and the vapor compression system 14 by conduits 24. The heat exchanger in the air handler 22 may receive either heated liquid from the boiler 16 or the conditioning fluid (e.g., chilled liquid such as water) from the vapor compression system 14, depending on the mode of operation of the HVAC&R system 10. The HVAC&R system 10 is shown with a separate air handler on each floor of building 12, but in other embodiments, the HVAC&R system 10 may include air handlers 22 and/or other components that may be shared between or among floors.

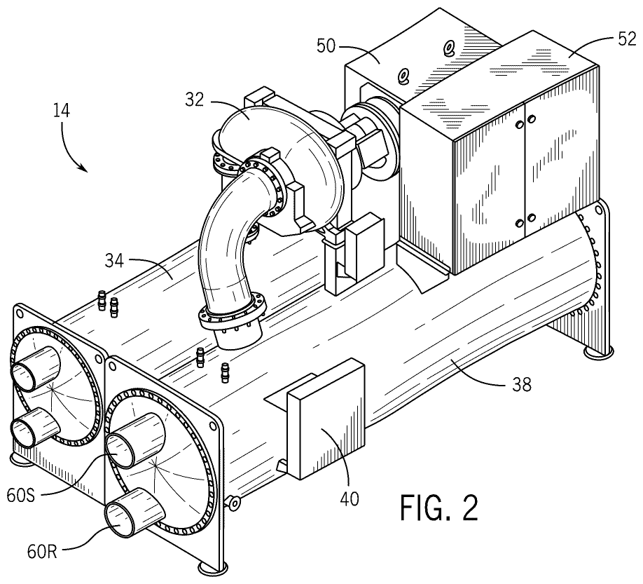

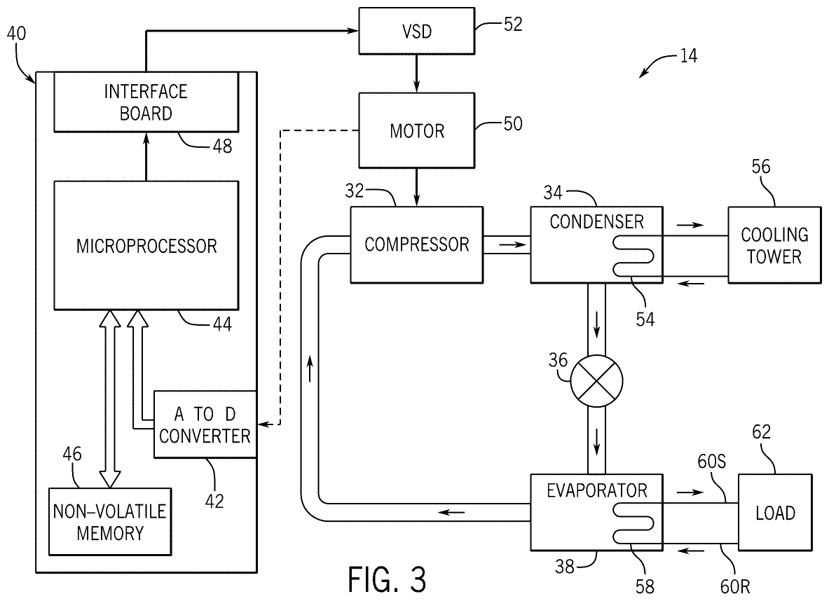

FIGS. 2 and 3 illustrate embodiments of the vapor compression system 14, or chiller, which can be used in the HVAC&R system 10. The vapor compression system 14 may circulate a working fluid through a working fluid circuit (e.g., refrigerant loop) starting with a compressor 32, such as a centrifugal compressor. The circuit may also include a condenser 34, an expansion valve(s) or device(s) 36, and an evaporator 38. The vapor compression system 14 may further include a control panel 40 that has an analog to digital (A/D) converter 42, a microprocessor 44, a non-volatile memory 46, and/or an interface board 48.

Some examples of fluids that may be used as working fluids in the vapor compression system 14 are hydrofluorocarbon (HFC) based refrigerants, for example, R-410A, R-407, R-134a, hydrofluoro olefin (HFO), “natural” refrigerants like ammonia (NH₃), R-717, carbon dioxide (CO₂), R-744, or hydrocarbon-based refrigerants, water vapor, or any other suitable working fluids. Other possible working fluids include R-123, R-514A, R-1224yd, R-1233zd, R-134a, R-1234ze, R-1234yf, R-1142ze, R-1142yf, R-1311, R-32, and R-410A. In some embodiments, the vapor compression system 14 may be configured to efficiently utilize working fluids having a normal boiling point of about 19 degrees Celsius (66 degrees Fahrenheit) at one atmosphere of pressure, also referred to as low pressure working fluids, versus a medium pressure working fluid, such as R-134a. As used herein, “normal boiling point” may refer to a boiling point temperature measured at one atmosphere of pressure.

In some embodiments, the vapor compression system 14 may use one or more of a variable speed drive (VSDs) 52, a motor 50, the compressor 32, the condenser 34, the expansion valve or device 36, and/or the evaporator 38. The motor 50 may drive the compressor 32 during a normal operating mode and may be powered by a variable speed drive (VSD) 52. The VSD 52 receives alternating current (AC) power during the normal operating mode, where the AC power includes a particular fixed line voltage and fixed line frequency from an AC power source, and provides power having a variable voltage and frequency to the motor 50. In other embodiments, the motor 50 may be powered directly from an AC or direct current (DC) power source. The motor 50 may include any type of electric motor that can be powered by a VSD or directly from an AC or DC power source, such as a switched reluctance motor, an induction motor, an electronically commutated permanent magnet motor, or another suitable motor.

The compressor 32 compresses a working fluid vapor and delivers the vapor to the condenser 34 through a discharge passage. In some embodiments, the compressor 32 may be a centrifugal compressor. The working fluid vapor delivered by the compressor 32 to the condenser 34 may transfer heat to a cooling fluid (e.g., water or air) in the condenser 34. The working fluid vapor may condense to a working fluid liquid in the condenser 34 as a result of thermal heat transfer with the cooling fluid. The liquid working fluid from the condenser 34 may flow through the expansion device 36 to the evaporator 38. In the illustrated embodiment of FIG. 3, the condenser 34 is water cooled and includes a tube bundle 54 connected to a cooling tower 56, which supplies the cooling fluid to the condenser 34.

The liquid working fluid delivered to the evaporator 38 may absorb heat from a conditioning fluid that is subsequently routed to a load 62 (e.g., the building 12 of FIG. 1). For example, the conditioning fluid may be cooled by the working fluid in the evaporator 38, and then may be utilized in the building 12 of FIG. 1 to condition an air flow provided to condition a space in the building 12. The liquid working fluid in the evaporator 38 may undergo a phase change from the liquid working fluid to a working fluid vapor. As shown in the illustrated embodiment of FIG. 3, the evaporator 38 may include a tube bundle 58 having a supply line 60S and a return line 60R connected to the cooling load 62. The conditioning fluid of the evaporator 38 (e.g., water, ethylene glycol, calcium chloride brine, sodium chloride brine, or any other suitable fluid) enters the evaporator 38 via return line 60R and exits the evaporator 38 via supply line 60S. The evaporator 38 may reduce the temperature of the conditioning fluid in the tube bundle 58 via thermal heat transfer with the working fluid. The tube bundle 58 in the evaporator 38 can include a plurality of tubes and/or a plurality of tube bundles. In any case, the vapor working fluid exits the evaporator 38 and returns to the compressor 32 by a suction line to complete the cycle.

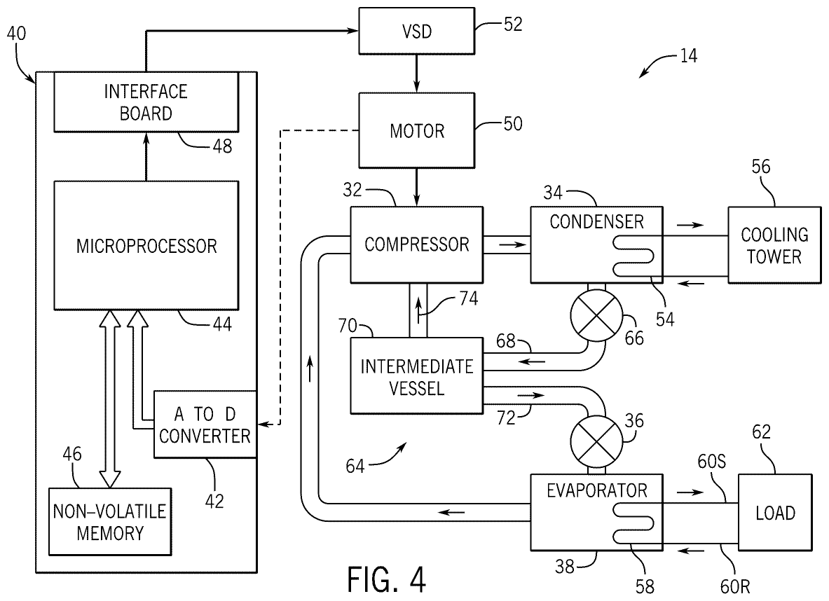

FIG. 4 is a schematic of an embodiment of the vapor compression system 14 with an intermediate circuit 64 incorporated between the condenser 34 and the expansion device 36. The intermediate circuit 64 may have an inlet line 68 that is directly fluidly connected to the condenser 34. In other embodiments, the inlet line 68 may be indirectly fluidly coupled to the condenser 34. As shown in the illustrated embodiment of FIG. 4, the inlet line 68 includes a first expansion device 66 positioned upstream of an intermediate vessel 70. In some embodiments, the intermediate vessel 70 may be a flash tank (e.g., a flash intercooler). In other embodiments, the intermediate vessel 70 may be configured as a heat exchanger or a “surface economizer.” In the illustrated embodiment of FIG. 4, the intermediate vessel 70 is used as a flash tank, and the first expansion device 66 is configured to lower the pressure of (e.g., expand) the liquid working fluid received from the condenser 34. During the expansion process, a portion of the liquid working fluid may vaporize, and thus, the intermediate vessel 70 may be used to separate the vapor working fluid from the liquid working fluid received from the first expansion device 66. Additionally, the intermediate vessel 70 may provide for further expansion of the liquid working fluid due to a pressure drop experienced by the liquid working fluid when entering the intermediate vessel 70 (e.g., due to a rapid increase in volume experienced when entering the intermediate vessel 70). The vapor working fluid in the intermediate vessel 70 may be drawn by the compressor 32 through a suction line 74 of the compressor 32. In other embodiments, the vapor working fluid in the intermediate vessel 70 may be drawn to an intermediate stage of the compressor 32 (e.g., not the suction stage). The liquid working fluid that collects in the intermediate vessel 70 may be at a lower enthalpy than the liquid working fluid exiting the condenser 34 due to expansion of the working fluid at the expansion device 66 and/or in the intermediate vessel 70. The liquid working fluid from intermediate vessel 70 may then flow through line 72 and through a second expansion device 36 to the evaporator 38.

In accordance with present embodiments, the compressor 32 may be a centrifugal compressor (e.g., a hermetic compressor) having a levitated rotor or shaft. To this end, the vapor compression system 14 includes a bearing system with one or more bearings configured to support a load of the shaft of the compressor 32. The bearing system is configured to direct a pressurized fluid (e.g., liquid) through the bearings, and the bearings are configured to discharge the fluid toward and against the shaft in order to enable levitation of the shaft within the compressor 32. Specifically, the bearings include one or more porous bearing elements configured to receive the pressurized fluid and direct the pressurized fluid toward the shaft within a housing of the compressor 32. In this way, the bearing system may support a load on the shaft and enable rotation of the shaft within the housing of the compressor 32 during operation of the vapor compression system 14. As discussed herein, the pressurized fluid may be a working fluid (e.g., refrigerant) circulated through the vapor compression system 14 (e.g., through a working fluid circuit of the vapor compression system 14). Thus, the vapor compression system 14 may not utilize a dedicated lubricant, such as oil, to support and enable rotation of the shaft of the compressor 32. Further, the bearing system may be incorporated with the vapor compression system 14 at reduced costs, as compared to other existing bearing system designs. As described further below, the disclosed embodiments also enable improved (e.g., simplified) control of the bearing system, as well as more efficient operation of the vapor compression system 14.

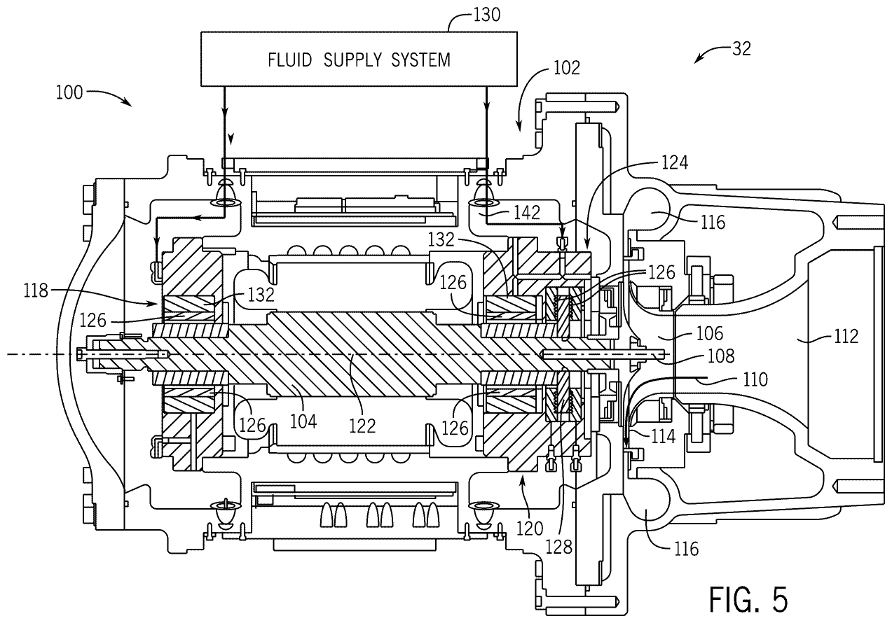

With the foregoing in mind, FIG. 5 is a cross-sectional side view of an embodiment of the compressor 32 including a bearing system 100, in accordance with aspects of the present disclosure. The compressor 32 may include a housing 102 and a shaft 104 extending through the housing 102. The compressor 32 may also include an impeller 106 coupled to the shaft 104, such as via a fastener 108. During operation of the compressor 32, the shaft 104 may rotate (e.g., via operation of the motor 50) and cause rotation of the impeller 106. Rotation of the impeller 106 may drive a working fluid (e.g., refrigerant) to flow through a working fluid flow path 110 (e.g., working fluid circuit, from the evaporator 38, from the intermediate vessel 70) to draw the working fluid into the housing 102 via a suction inlet 112 and toward the impeller 106. The impeller 106 may impart mechanical energy onto the working fluid and discharge the working fluid to a diffuser passage 114 of the compressor 32. The working fluid may be directed from the diffuser passage 114 to a volute 116 of the compressor 32 and from the volute 116 to a condenser (e.g., the condenser 34) for heat exchange with a fluid, such as a cooling fluid.

In the illustrated embodiment, the compressor 32 (e.g., bearing system 100) includes a first bearing 118 (e.g., a radial bearing, bearing assembly, porous bearing) and a second bearing 120 (e.g., a radial bearing, bearing assembly, porous bearing) configured to control and/or adjust a position (e.g., radial position) of the shaft 104 relative to an axis 122 (e.g., rotational axis, central axis) of the shaft 104. For example, the first bearing 118 and the second bearing 120 may be configured to support a load (e.g., radial load) of the shaft 104, such that the shaft 104 levitates within the first bearing 118 and the second bearing 120 (e.g., within the housing 102). The first bearing 118 and the second bearing 120 may also be configured to block movement (e.g., bending, radial movement, eccentric rotation) of the shaft 104 crosswise to the axis 122. The compressor 32 (e.g., bearing system 100) further includes a third bearing 124 (e.g., thrust bearing, axial bearing, bearing assembly, porous bearing) configured to control and/or adjust a position (e.g., axial position) of the shaft 104 along the axis 122. For example, the third bearing 124 may be configured to block or limit movement (e.g., translation) of the shaft 104 along the axis 122.

As mentioned above, the bearing system 100 is configured to direct a pressurized fluid to bearings of the bearing system 100, such as the first bearing 118, the second bearing 120, and/or the third bearing 124. The pressurized fluid may be the same working fluid (e.g., refrigerant) circulated through the vapor compression system 14 having the compressor 32. However, it should be appreciated that the pressurized fluid may be any suitable fluid, such as a refrigerant, a condensable vapor, or other fluid. In some embodiments, the first bearing 118, the second bearing 120, and/or the third bearing 124 each include one or more porous elements 126 configured to direct the pressurized fluid therethrough. For example, the one or more porous elements 126 of the first bearing 118 and the second bearing 120 may be configured to received pressurized fluid and direct the pressurized fluid towards the shaft 104 to establish a high-pressure fluid film (e.g., vapor film) about the shaft 104 between the first bearing 118 and the second bearing 120 and the shaft 104. In this way, the pressurized fluid may cause the shaft 104 to levitate from the first bearing 118 and the second bearing 120, thereby enabling desired rotation of the shaft 104 about the axis 122. The one or more porous elements 126 of the third bearing 124 may receive pressurized fluid and direct the pressurized fluid towards a collar 128 (e.g., thrust collar) of the third bearing 124. In this way, the pressurized fluid may apply a force to the collar 128 and enable adjustable positioning of the shaft 104 along the axis 122.

The bearing system 100 includes a fluid supply system 130 configured to supply pressurized fluid to the bearings (e.g., first bearing 118, second bearing 120, and/or third bearing 124) of the bearing system 100. For example, the fluid supply system 130 may direct the pressurized fluid through the housing 102 of the compressor 32 to one or more bearing housings 132 (e.g., casings) of the first bearing 118, the second bearing 120, and the third bearing 124. In the illustrated embodiment, one bearing housing 132 is associated with the first bearing 118, and another bearing housing 132 is associated with the second bearing 120. An additional bearing housing 132 may be utilized with the third bearing 124. In other embodiments, the second bearing 120 and the third bearing 124 may be packaged together in a common bearing housing 132. The pressurized fluid may be directed through the bearing housings 132 to the corresponding porous elements 126 retained within each bearing housing 132. The fluid supply system 130 is described in further detail below. It should be appreciated that the compressor 32 may include any suitable number or type (e.g., radial, axial) of bearings incorporating the present techniques, and the bearings may be positioned at any suitable location within the housing 102 of the compressor 32.

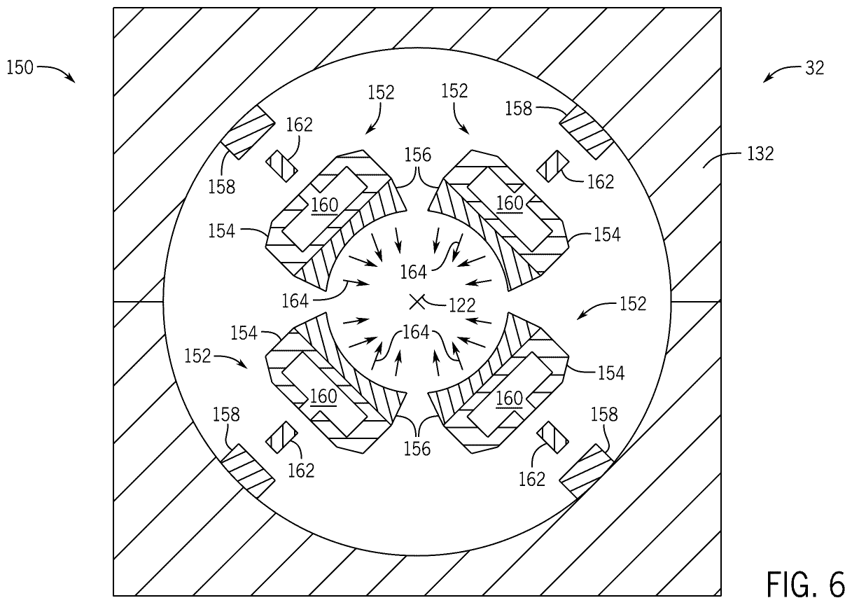

FIG. 6 is an axial view of a portion of an embodiment of the compressor 32 including a bearing assembly 150 (e.g., bearing, radial bearing), in accordance with aspects of the present disclosure. For example, the bearing assembly 150 may be an embodiment of the first bearing 118 or the second bearing 120 discussed above. In other words, the bearing assembly 150 is a radial bearing assembly configured to support (e.g., levitate) the shaft 104 within the housing 102 of the compressor 32. The bearing assembly 150 includes the bearing housing 132 and a radial bearing 152 (e.g., bearing portion, bearing segment, radial bearing element) configured to couple to the bearing housing 132. The radial bearing 152 may be described as a bearing segment, bearing portion, or bearing portion, in some embodiments, and the radial bearings 152 may cooperatively form or define a radial bearing (e.g., bearing assembly 150) of the compressor 32. It should be noted that the illustrated embodiment includes four radial bearings 152 (e.g., bearing segments), but the bearing assembly 150 may include any suitable number of radial bearings 152, such as two, three, five, six, or more radial bearings 152 (e.g., arrayed about a circumference of the shaft 104).

The radial bearing 152 includes a base portion 154 and a pad portion 156 coupled to the base portion 154. The radial bearing 152 is configured to structurally couple to the bearing housing 132 via a mounting portion 158 of the bearing housing 132. For example, the mounting portion 158 may be a post having threads, pins, or other suitable features to enable adjustable positioning (e.g., radial position, relative to axis 122) of the radial bearing 152 relative to the bearing housing 132. The mounting portion 158 may also enable adjustable positioning of the radial bearing 152 relative to the axis 122 and the shaft 104, which may enable installation of the radial bearing 152 in a pre-loaded (e.g., in contact) arrangement with the shaft 104. Thus, when the bearing system 100 is not in operation, the pad portion 156 of one or more of the radial bearings 152 may be in contact with the shaft 104 (e.g., via force of gravity on the shaft 104).

The base portion 154 of the radial bearing 152 may be formed from any suitable material, such as a metallic material. The base portion 154 also includes a cavity 160 (e.g., internal volume) formed within the base portion 154. The cavity 160 is configured to receive a flow of pressurized fluid from the fluid supply system 130. To this end, the bearing assembly 150 also includes one or more transfer conduits 162 (e.g., fluid conduits, fluid transfer conduits) configured to fluidly couple the bearing housing 132 to the cavities 160 of the radial bearings 152. For example, in some embodiments, multiple transfer conduits 162 may be included with the bearing assembly 150, and each transfer conduit 162 may be fluidly coupled to one of the cavities 160 of the radial bearings 152. In an assembled configuration, the transfer conduit 162 may extend into (e.g., thread into) the base portion 154. The transfer conduit 162 may also extend (e.g., thread into) into the mounting portion 158. For example, the mounting portion 158 may also define a port to fluidly couple a passage or conduit within the bearing housing 132 to the transfer conduit 162. Therefore, for each radial bearing 152 (e.g., bearing segment), a portion of a flow of pressurized fluid directed into the bearing housing 132 may flow through the bearing housing 132, through the mounting portion 158, through the transfer conduit 162, and into the cavity 160 of the base portion 154.

The cavity 160 of the base portion 154 is fluidly coupled and/or exposed to the pad portion 156. In accordance with present techniques, the pad portion 156 is formed from a porous material. In other words, the porous material of the pad portion 156 may define a plurality of channels or passages through which a fluid may flow. In some embodiments, the pad portion 156 is formed from a metallic material, such as carbon, graphite, sintered metal, and/or a matrix of metallic materials. The pad portion 156 may also have a contour or geometry that corresponds to a contour or geometry of the shaft 104. As pressurized fluid is supplied to the cavity 160, the pressurized fluid may be forced through the porous material of the pad portion 156 and may be discharged from the pad portion 156 towards the axis 122 and/or the shaft 104, as indicated by arrows 164. As described in further detail below, the size of the passages defined by the porous material of the pad portion 156 may cause the pressurized fluid (e.g., pressurized liquid) to vaporize or flash, such that the fluid is discharged from the radial bearing 152 as a vapor or gas. In this way, the gaseous fluid may form a high-pressure film between the radial bearing 152 and the shaft 104 and enable levitation of the shaft 104 from the radial bearing 152. Additionally, during operation of the compressor 32, and thus during rotation of the shaft 104, the high-pressure film between the radial bearings 152 and the shaft 104 may facilitate rotation of the shaft 104 with reduced friction, improved efficiency, and so forth.

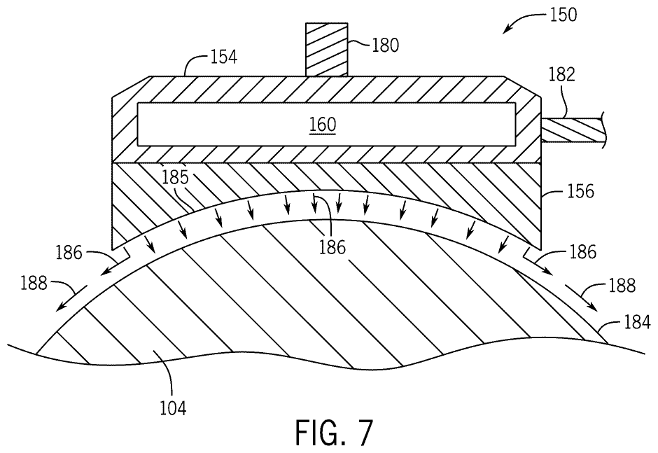

FIG. 7 is a schematic of a portion of an embodiment of the bearing assembly 150 (e.g., radial bearing 152), illustrating the pad portion 156 formed from a porous material, such as a porous metallic material (e.g., carbon). The illustrated embodiment also includes a mounting portion 180 coupled to and extending from the base portion 154. The mounting portion 180 may be configured to enable mounting of the radial bearing 152 to the bearing housing 132 of the bearing assembly 150. In other embodiments, the pad portion 156 may be a component of the third bearing 124 (e.g., thrust bearing) discussed above. As similarly described above, the base portion 154 defines the cavity 160, which is configured to receive a flow of pressurized fluid from the fluid supply system 130. In other embodiments, the bearing assembly 150 may not include the base portion 154 and may include the pad portion 156 having the cavity 160 formed therein.

Additionally, a fluid supply port 182 extends from the base portion 154. The fluid supply port 182 is configured to receive a flow of the pressurized fluid from the fluid supply system 130 and direct the pressurized fluid into the cavity 160. For example, the fluid supply port 182 may be fluidly coupled to a conduit extending through the bearing housing 132 and/or the housing 102 of the compressor 32. As similarly discussed above, the pressurized fluid within the cavity 160 (e.g., a liquid) may be forced through the porous material of the pad portion 156 and may be discharged from a radially-inward surface 185 (e.g., surface facing the shaft 104) of the pad portion 156 (e.g., as a vapor or gas) towards a guiding surface 184, as indicated by arrows 186. For example, the guiding surface 184 may be a surface of the shaft 104 disposed within (e.g., radially internal to) the first bearing 118 and/or second bearing 120, or the guiding surface 184 may be a surface of the collar 128 of the third bearing 124. The fluid (e.g., gas, vapor) discharged from the pad portion 156 may create a film 188 (e.g., aerostatic film, high-pressure vapor film) between the pad portion 156 and the guiding surface 184, which enables relative movement (e.g., rotation) between the pad portion 156 and the guiding surface 184. The high pressure of the film 188 may also enable levitation of the shaft 104 within (e.g., radially within) the bearing assembly 150 having the radial bearings 152. Indeed, as the radial bearings 152 may be arrayed about a circumference of the shaft 104, the film 188 may be generated by the radial bearings 152 to enable centering of the shaft 104 within the bearing assembly 150, such that the shaft 104 is radially offset from each of the radial bearings 152.

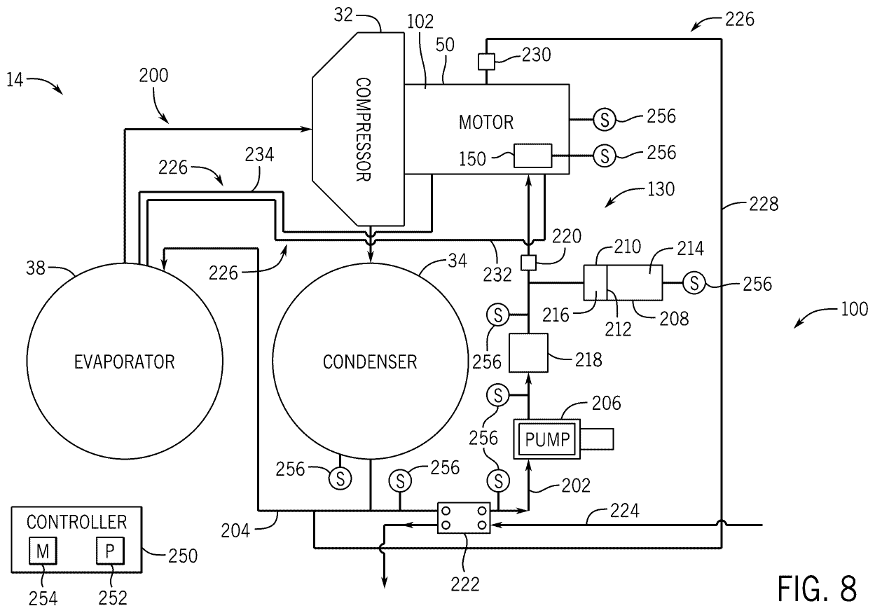

FIG. 8 is a schematic of an embodiment of the vapor compression system 14 (e.g., HVAC&R system) including the bearing system 100 for the compressor 32. The vapor compression system 14 includes elements similar to those discussed above, including the compressor 32, the motor 50, the condenser 34, and the evaporator 38 (e.g., falling film evaporator) arranged along a working fluid circuit 200 (e.g., refrigerant circuit). In accordance with present techniques, the bearing system 100 also includes the fluid supply system 130 configured to direct pressurized fluid to the bearings (e.g., bearing assemblies 150) of the bearing system 100. In particular, the fluid supply system 130 is configured to direct a portion of working fluid circulated through the working fluid circuit 200 to the bearing assemblies 150. To this end, the fluid supply system 130 includes a lubricant circuit 202 (e.g., fluid supply circuit) extending from the working fluid circuit 200 to the bearing assemblies 150 (e.g., to the radial bearings 152).

In the illustrated embodiment, the lubricant circuit 202 extends from a liquid line portion 204 of the working fluid circuit 200 to the bearing assemblies 150. The liquid line portion 204 extends from the condenser 34 to the evaporator 38. Thus, working fluid within the liquid line portion 204 may be in a liquid phase. Various components are disposed along the lubricant circuit 202 and are configured to enable desirable supply of working fluid to the bearing assemblies 150 to enable the bearing assemblies 150 to support a load of the shaft 104 of the compressor 32. For example, the fluid supply system 130 includes a pump 206 (e.g., liquid pump) disposed along the lubricant circuit 202 and configured to direct flow of working fluid (e.g. liquid working fluid) along the lubricant circuit 202 from the liquid line portion 204 of the working fluid circuit 200 to the bearing assemblies 150 of the motor 50 (e.g., compressor 32). The pump 206 may be a linear piston pump, in some embodiments, and the pump 206 may be driven electrically, pneumatically, mechanically, electromechanically, and/or via another suitable technique. In some embodiments, the pump 206 may operate without utilizing oil or other dedicated lubricant.

The fluid supply system 130 also includes a pressure accumulator 208 fluidly coupled to the lubricant circuit 202. The pressure accumulator 208 is fluidly coupled to the lubricant circuit 202 downstream of the pump 206 relative to a flow of working fluid along the lubricant circuit 202. Thus, the pressure accumulator 208 may receive a pressurized flow of working fluid (e.g., liquid working fluid, vapor working fluid, or both) from the pump 206 and the lubricant circuit 202. As will be appreciated, the pressure accumulator 208 is configured to store pressurized working fluid therein. For example, the pressure accumulator 208 may include a vessel 210 and a separator 212 (e.g., bladder, diaphragm, piston, etc.) disposed therein. In some embodiments, the separator 212 may divide an internal volume of the vessel 210 into a biasing chamber 214 (e.g., gas chamber) on a first side of the separator 212 and a fluid chamber 216 (e.g., liquid chamber, working fluid chamber) on a second side the separator 212. The fluid chamber 216 of the pressure accumulator 208 is configured to receive pressurized working fluid from the lubricant circuit 202. The separator 212 may be a bladder or other flexible container pre-charged with a gas (e.g., nitrogen) to enable maintaining the pressure of the working fluid within the fluid chamber 216. In other embodiments, the biasing chamber 214 may be pre-charged with a gas. In still further embodiments, the biasing chamber 214 may instead include a spring or other mechanical biasing component. In any case, the pressure accumulator 208 may operate as a mechanical battery configured to enable supply (e.g., temporary supply) of pressurized working fluid from the fluid chamber 216 to the bearing assemblies 150 via the lubricant circuit 202, such as during periods of non-operation of the pump 206 (e.g., loss of power to the pump 206). For example, during an interruption in operation of the pump 206, the pressure accumulator 208 may discharge pressurized working fluid to the lubricant circuit 202 for supply to the bearing assemblies 150. In this way, the bearing assemblies 150 may continue to operate to support a load on the shaft 104 (e.g., levitate the shaft 104) while operation of the pump 206 is restarted and/or while operation of the compressor 32 (e.g., the motor 50) is suspended in a controlled manner. In some embodiments, the pressure accumulator 208 may also operate to damp oscillations in the flow of pressurized working fluid directed to the bearing assemblies 150. Further, the pressure accumulator 208 may be configured to supply pressurized working fluid to the bearing assemblies 150 at startup of the vapor compression system 14 (e.g., prior to operation of the pump 206 and/or the compressor 32).

The fluid supply system 130 may also include other components disposed along the lubricant circuit 202, such as a check valve 218 (e.g., check ball valve) disposed between the pump 206 and the pressure accumulator 208. The check valve 218 may be configured to close and block flow of liquid working fluid from the pump 206 and along the lubricant circuit 202 toward the bearing assemblies 150 based on a pressure of the liquid working fluid discharged by the pump 206. For example, in response to a pressure of the liquid working fluid discharged by the pump 206 falling below a threshold value (e.g., a threshold value corresponding to a liquid working fluid pressure desired for supply to the bearing assemblies 150), the check valve 218 may close. In such instances, pressurized liquid working fluid stored within the pressure accumulator 208 may be supplied to the bearing assemblies 150 (e.g., with the closed check valve 218 blocking working fluid flow back to the pump 206) to enable at least temporary continued operation of the bearing assemblies 150 to support the shaft 104 with liquid working fluid supplied to the bearing assemblies 150 at a desired pressure via the pressure accumulator 208.

In some embodiments, the fluid supply system 130 may include a filter 220 disposed along the lubricant circuit 202 (e.g., downstream of the pressure accumulator 208 and upstream up the bearing assemblies 150). The filter 220 (e.g., may be configured to remove particulates and/or moisture (e.g., water, water vapor) from the liquid working fluid prior to the liquid working fluid being directed to the bearing assemblies 150.

The fluid supply system 130 may also include a heat exchanger 222 disposed along the lubricant circuit 202. The heat exchanger 222 is disposed upstream of the pump 206 relative to a flow direction of the working fluid through the lubricant circuit 202. In some embodiments, the heat exchanger 222 may be a brazed-plate heat exchanger. In operation, the heat exchanger 222 may function as a subcooler configured to subcool working fluid directed from the liquid line portion 204 into the lubricant circuit 202. In this way, the heat exchanger 222 may operate to ensure that the working fluid supplied to the pump 206 is in a liquid phase, which may reduce undesired effects, such as flashing of the refrigerant at the pump 206, cavitation of the pump 206, and so forth. The heat exchanger 222 is configured to place the working fluid drawn from the liquid line portion 204 in a heat exchange relationship with a cooling fluid (e.g., auxiliary cooling fluid) directed to the heat exchanger 222 via a cooling fluid circuit 224. The cooling fluid may be water, in some embodiments. In such embodiments, the cooling fluid circuit 224 may be configured to supply the cooling fluid from an external source. Additionally or alternatively, the cooling fluid circuit 224 may be configured to supply water or other cooling fluid (e.g., cooled via the evaporator 38) from a conditioning fluid conduit, such as the supply line 60S and/or the return line 60R described above. In some embodiments, the cooling fluid may be another portion of working fluid from the working fluid circuit 200. In such embodiments, the cooling fluid circuit 224 may extend from the working fluid circuit 200 (e.g., the liquid line portion 204) to the heat exchanger 222. However, it should be appreciated that the cooling fluid circuit 224 may be configured to direct any suitable cooling fluid to the heat exchanger 222 to enable cooling (e.g., subcooling) of the portion of the working fluid directed along the lubricant circuit 202 toward the bearing assemblies 150 of the compressor 32.

As mentioned above, the bearing assemblies 150 are configured to receive pressurized working fluid (e.g., refrigerant) and to discharge the working fluid towards the shaft 104 or collar 128. In particular, the bearing assemblies 150 each include one or more porous elements configured to direct the pressurized working fluid therethrough and to flash the pressurized working fluid and discharge pressurized vapor working fluid towards the shaft 104 or collar 128. Thereafter, the working fluid may flow through the housing 102 of the compressor 32 (e.g., motor 50) to one or more drain lines 226 of the bearing system 100. The drain lines 226 may be fluidly coupled to an interior of the housing 102. For example, the bearing system 100 may include a first drain line 228 extending from the housing 102 of the compressor 32 to the liquid line portion 204 of the working fluid circuit 200. The first drain line 228 may include a valve 230 (e.g., electronic expansion valve) and/or may be configured to direct vapor working fluid from within the housing 102 to the liquid line portion 204 of the working fluid circuit 200. Additionally or alternatively, the bearing system 100 may include a second drain line 232 extending from the housing 102 to the evaporator 38 and/or a third drain line 234 extending from the housing 102 to the evaporator 38. In some embodiments, the second drain line 232 is configured to direct vapor working fluid from the housing 102 to the evaporator 38, and the third drain line 234 is configured to direct liquid working fluid from the housing 102 to the evaporator 38. In other words, working fluid utilized by the bearing assemblies 150 may collect within the housing 102 of the compressor 32 in a vapor phase (e.g., gaseous phase), a liquid phase, or both, and the bearing system 100 (e.g., fluid supply system 130) may be configured to collect and return (e.g., separately return) portions of the working fluid in different phase to different portions of the working fluid circuit 200.

The vapor compression system 14 may also include a controller 250 (e.g., a control system, control board, control panel) communicatively coupled to one or more components of the vapor compression system 14 and/or the bearing system 100. The controller 250 is configured to monitor, adjust, and/or otherwise control operation of the components of the vapor compression system 14, the bearing system 100, and/or the fluid supply system 130. For example, one or more control transfer devices, such as wires, cables, wireless communication devices, and the like, may communicatively couple the compressor 32, the motor 50, the pump 206, and/or any other components described herein. Such components may include a network interface that enables the components of the vapor compression system 14 and/or bearing system 100 to communicate via various protocols such as EtherNet/IP, ControlNet, DeviceNet, or any other communication network protocol. Alternatively, the communication component may enable the components of the vapor compression system 14 and/or bearing system 100 to communicate via mobile telecommunications technology, Bluetooth®, near-field communications technology, and the like.

In some embodiments, the controller 250 may include a portion or all of the control panel 40 or may be another suitable controller included in the vapor compression system 14 and/or the bearing system 100. In any case, the controller 250 may be configured to control components of the vapor compression system 14 and/or the bearing system 100 in accordance with the techniques discussed herein. The controller 250 includes processing circuitry 252, such as one or more microprocessors, which may execute software for controlling the components of the vapor compression system 14 and/or the bearing system 100. The processing circuitry 252 may include multiple microprocessors, one or more “general-purpose” microprocessors, one or more special-purpose microprocessors, and/or one or more application specific integrated circuits (ASICS), or some combination thereof. For example, the processing circuitry 252 may include one or more reduced instruction set (RISC) processors.

The controller 250 may also include a memory device 254 (e.g., a memory) that may store information such as instructions, control software, look up tables, configuration data, etc. The memory device 254 may include a volatile memory, such as random access memory (RAM), and/or a nonvolatile memory, such as read-only memory (ROM). The memory device 254 may store a variety of information and may be used for various purposes. For example, the memory device 254 may store processor-executable instructions including firmware or software for the processing circuitry 252 to execute, such as instructions for controlling components of the vapor compression system 14 and/or the bearing system 100. In some embodiments, the memory device 254 is a tangible, non-transitory, machine-readable-medium that may store machine-readable instructions for the processing circuitry 252 to execute. The memory device 254 may include ROM, flash memory, a hard drive, or any other suitable optical, magnetic, or solid-state storage medium, or a combination thereof. The memory device 254 may store data, instructions, and any other suitable data. It should be appreciated that the memory device 254 may store processor-executable instructions (e.g., for execution via the processing circuitry 252) to enable operation of any of the components described herein and to enable any of the functionalities and/or operations described herein.

The controller 250 may be configured to control operation of components of the vapor compression system 14, the bearing system 100, and/or the fluid supply system 130 based on detected operating parameters of the vapor compression system 14, the bearing system 100, and/or the fluid supply system 130. To this end, the vapor compression system 14 (e.g., bearing system 100, fluid supply system 130) includes one or more sensors 256 configured to detect operating parameters associated with or indicative of operating conditions of the vapor compression system 14, the bearing system 100, and/or the fluid supply system 130. For example, one or more of the sensors 256 may be disposed along the lubricant circuit 202 and may be configured to detect operating parameters of the working fluid directed through the lubricant circuit 202, such as temperature, pressure, flow rate, and so forth. In some embodiments, one or more sensors 256 may be configured to detect an operating parameter associated with the motor 50, such as a rotational speed of the shaft 104, a torque on the shaft 104, a temperature of the motor 50, a temperature within the housing 102, and so forth. One or more sensors 256 may be configured to detect an operating parameter of the bearing assemblies 150, such as a detection of whether one or more bearing assemblies 150 is in contact (e.g., physical contact) with the shaft 104, as described further below.

In some embodiments, one of the sensors 256 may be configured to detect an operating parameter associated with the pressure accumulator 208, such as a pressure of working fluid within the fluid chamber 216 and/or a pressure of gas within the biasing chamber 214. Additionally or alternatively, one or more of the sensors 256 may be configured to detect a liquid level of working fluid within the condenser 34, which may be referenced before and/or during startup of the bearing system 100, the fluid supply system 130, and/or the vapor compression system 14. As will be appreciated, each sensor 256 included in the vapor compression system 14 may be communicatively coupled to the controller 250. Thus, the controller 250 may receive data and/or feedback from the sensors 256 and may control operation of the vapor compression system 14, the bearing system 100, and/or the fluid supply system 130 based on the feedback and/or data.

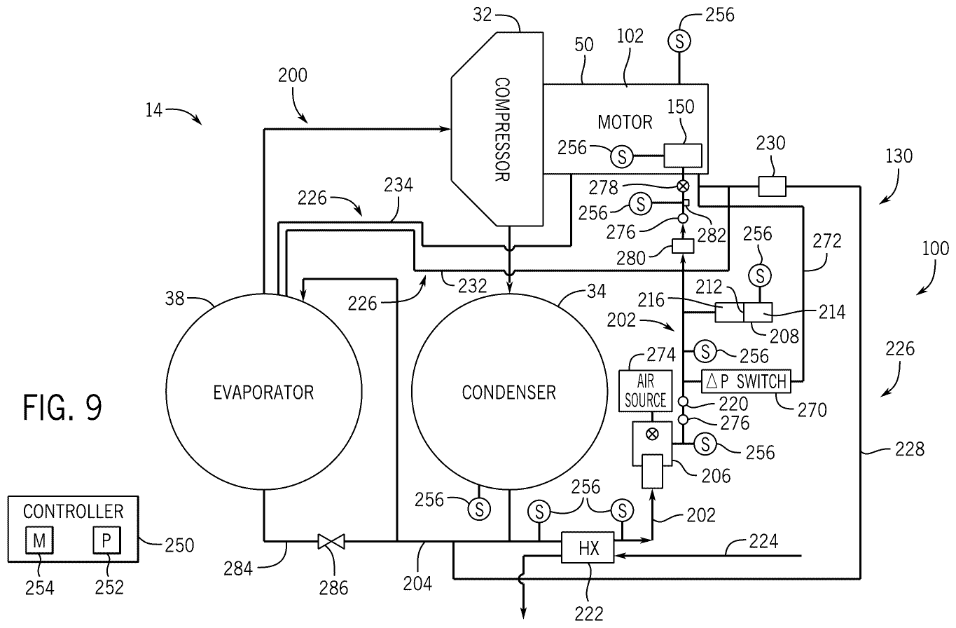

FIG. 9 is a schematic of an embodiment of the vapor compression system 14 (e.g., HVAC&R system) including the bearing system 100 and the fluid supply system 130 for the compressor 32. The illustrated embodiment includes similar elements and elements numbers as the embodiment described above with reference to FIG. 8, including the lubricant circuit 202, the heat exchanger 222 (e.g., brazed-plate heat exchanger), the pressure accumulator 208, the pump 206 (e.g., liquid pump), the drain lines 226, the bearing assemblies 150, and the sensors 256. The illustrated embodiment also includes additional features that may be incorporated with the bearing system 100 (e.g., the fluid supply system 130).

As shown, the bearing system 100 (e.g., fluid supply system 130) includes a differential pressure switch 270. The differential pressure switch 270 (e.g., switch, pressure switch) is fluidly coupled to the motor 50 (e.g., the housing 102, an interior volume of the housing 102) and to the lubricant circuit 202 via pressure circuit 272. The differential pressure switch 270 is configured to detect respective pressures associated with working fluid within the motor 50 (e.g., within the housing 102) and working fluid flowing within the lubricant circuit 202. For example, the differential pressure switch 270 may be fluidly coupled (e.g., via the pressure circuit 272) to working fluid within the bearing assemblies 150, working fluid discharged by the bearing assemblies 150 within the housing 102, the first drain line 228, or other suitable pressure associated with working fluid in the motor 50, the bearing assemblies 150, and/or the compressor 32. The differential pressure switch 270 is also fluidly coupled to the lubricant circuit 202 at a location downstream of the pump 206 relative to flow of working fluid through the lubricant circuit 202. Thus, the differential pressure switch 270 may be configured to compare respective pressures of working fluid within the motor 50 (e.g., housing 102, compressor 32) and working fluid discharged by the pump 206 along the lubricant circuit 202.

In some embodiments, the differential pressure switch 270 may be actuated in response to a differential pressure between working fluid discharged by the pump 206 (e.g., the lubricant circuit 202 downstream of the pump 206) and working fluid within or discharged by the motor 50 (e.g., bearing assemblies 150, pressure within the housing 102) falling below a differential pressure threshold value (e.g., 90 pounds per square inch). That is, the differential pressure switch 270 may be actuated in response to the pressure of working fluid discharged by the pump 206 not being greater than the pressure of working fluid within or discharged by the motor 50 (e.g., bearing assemblies 150) by at least a threshold amount (e.g., the differential pressure threshold value). Based on the actuation of the differential pressure switch 270, improper operation of the pump 206 may be detected. To this end, the differential pressure switch 270 may be communicatively coupled to the controller 250, and the controller 250 may be configured to adjust operation of one or more components of the vapor compression system 14 (e.g., the compressor 32, the motor 50) based on a signal received from the differential pressure switch 270 indicative of actuation of the differential pressure switch 270. For example, the controller 250 may be configured to shut down operation of the compressor 32 in a controlled manner in response to data or signals received from the differential pressure switch 270 indicative of the pressure of working fluid discharged by the pump 206 not being greater than the pressure of working fluid within or discharged by the motor 50 (e.g., bearing assemblies 150), such as by at least a threshold amount.

In the illustrated embodiment, the pump 206 is a pneumatic pump (e.g., linear piston pump). Accordingly, the pump 206 is fluidly coupled to an air source 274 configured to supply air (e.g., pressurized air) to the pump 206 to enable operation of the pump 206. The pump 206 may also include a relief valve configured to discharge pressure generated by the pump 206 that exceeds a threshold value. As will be appreciated, linear piston pumps may provide increased reliability and may be cost-effective components that enable supply of pressurized fluid through the lubricant circuit 202.

The lubricant circuit 202 may further include one or more additional components, such as one or more sight glasses 276 and one or more check valves 278. The sight glasses 276 may enable an operator to visually verify flow of working fluid through the lubricant circuit 202. In the illustrated embodiment, the check valve 278 may be configured to block backflow of working fluid from the motor 50 (e.g., from the bearing assemblies 150) into the lubricant circuit 202. The lubricant circuit 202 also includes a flow meter 280 (e.g., liquid flow meter) configured to detect flow (e.g., a flow rate) of working fluid (e.g., liquid working fluid) to the bearing assemblies 150 in the motor 50. The flow meter 280 is disposed downstream of the pump 206 and the pressure accumulator 208. The flow meter 280 may be communicatively coupled to the controller 250 and may provide data indicative of an amount (e.g., pressure, mass) of working fluid (e.g., liquid working fluid) provided to the bearing assemblies 150. In some embodiments, the lubricant circuit 202 may include one or more heating elements 282 (e.g., heat tape, resistive heater) coupled thereto. The heating elements 282 may be configured to heat the liquid working fluid within the lubricant circuit 202 prior to supply of the working fluid to the bearing assemblies 150. The heating elements 282 may also be communicatively coupled to the controller 250, and the controller 250 may control the heating elements 282 to heat the liquid working fluid within the lubricant circuit 202 by an amount that enables the liquid working fluid to flash (e.g., vaporize) upon discharge of the working fluid from the bearing assemblies 150 (e.g., from porous elements 126 of the bearing assemblies 150) toward the shaft 104.

In the illustrated embodiment, the working fluid circuit 200 further includes a liquid recirculation conduit 284 extending from a base of the evaporator 38 to the liquid line portion 204 of the working fluid circuit 200. As a result, liquid working fluid within the evaporator 38 may flow (e.g., via force of gravity) to the liquid line portion 204. Specifically, during non-operational periods of the vapor compression system 14, working fluid remaining within the evaporator 38 may condense to a liquid, and the liquid working fluid may be directed from the evaporator 38, via the liquid recirculation conduit 284, to the liquid line portion 204 that is fluidly coupled to the lubricant circuit 202. In this way, liquid working fluid may be desirably redirected to the liquid line portion 204 to ensure that adequate liquid working fluid is present in the liquid line portion 204 upon startup of the bearing system 100 and/or the fluid supply system 130. It should be appreciated that operation of the bearing system 100 and/or the fluid supply system 130 may be initialized (e.g., via the controller 250) prior to startup of the compressor 32 of the vapor compression system 14 (e.g., prior to rotation of the shaft 104). As described further below, the bearing system 100 and/or the fluid supply system 130 may be operated prior to operation of the compressor 32 (e.g., rotation of the shaft 104), and levitation of the shaft 104 within the compressor 32 (e.g., housing 102) and from the bearing assemblies 150 (e.g., radial bearings 152) may be verified prior to initializing operation of the motor 50 (e.g., rotation of the shaft 104) to ensure proper operation of the compressor 32 and/or to reduce undesired contact, wear, and/or degradation of components of the compressor 32. In some embodiments, the liquid recirculation conduit 284 may include a valve 286. The valve 286 may be closed (e.g., via the controller 250) during steady state operation of the vapor compression system 14 to block flow of working fluid from the evaporator 38 to the liquid line portion 204.

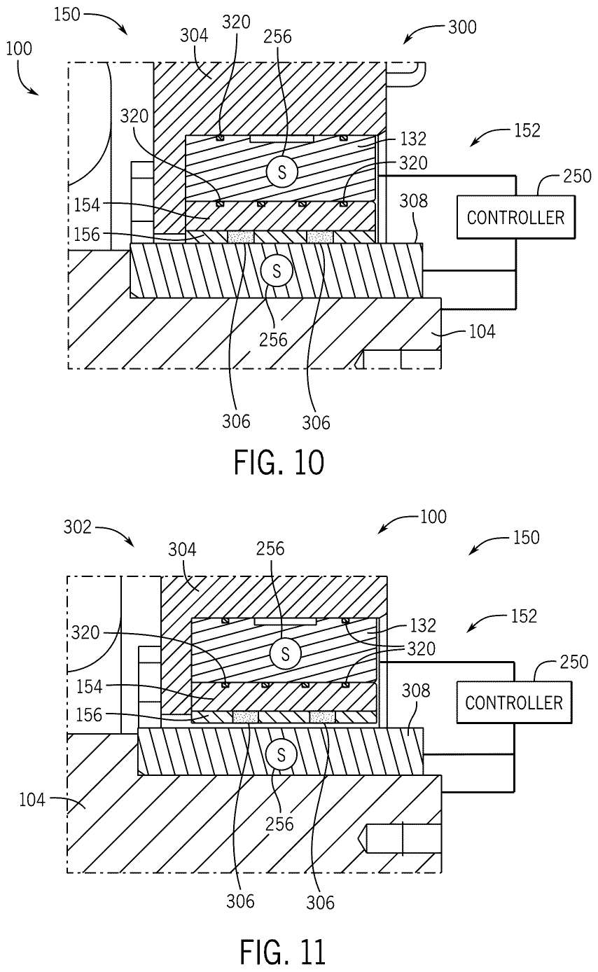

FIGS. 10 and 11 are schematics of a portion of an embodiment of compressor 32 and the bearing system 100, illustrating the bearing assembly 150 having an embodiment of the radial bearing 152. In particular, FIG. 10 illustrates the bearing assembly 150 in a first configuration 300, also referred to herein as a “contact configuration,” and FIG. 11 illustrates the bearing assembly 150 in a second configuration 302, also referred to herein as a “non-contact configuration.” FIGS. 10 and 11 are discussed concurrently below. The bearing assembly 150 includes similar elements and element numbers described above, including the bearing housing 132, the base portion 154, and the pad portion 156.

As similarly discussed above, the radial bearing 152 is configured to be disposed about the shaft 104 and is configured to control and/or adjust a position of the shaft 104 in a radial direction relative to the axis 122. In particular, the radial bearing 152 is configured to discharge pressurized fluid supplied via the lubricant circuit 202 toward the shaft 104 to enable levitation of the shaft 104 extending within (e.g., radially within) the bearing assembly 150 having the radial bearing 152. In this way, the radial bearing 152 enables efficient rotation of the shaft 104 within the housing 102 of the compressor 32. The bearing assembly 150 may include multiple radial bearings 152 circumferentially arrayed about the shaft 104. The one or more radial bearings 152 may be retained within a casing 304 of the motor 50 and/or the compressor 32. In some embodiments, the casing 304 may be a component of the housing 102. Alternatively, the casing 304 may be a separate component disposed within the housing 102, such as the bearing housing 132 described above.

In accordance with present techniques, the bearing system 100 is configured to detect contact between the shaft 104 and one or more of the radial bearings 152 (e.g., the pad portion 156). During operation of the vapor compression system 14 and/or the bearing system 100, the radial bearings 152 are configured to discharge working fluid towards the shaft 104 to enable levitation and/or separation of the shaft 104 from the radial bearings 152 and thereby enable desired rotation of the shaft 104 within the housing 102 with reduced friction and improved efficiency. However, in some instances, one or more of the radial bearings 152 may contact the shaft 104. For example, during non-operation of the vapor compression system 14, the bearing system 100, and/or the fluid supply system 130, the shaft 104 may rest (e.g., via force of gravity) on one or more of the radial bearings 152. Prior to operation of the compressor 32 (e.g., rotation of the shaft 104), operation of the bearing system 100 and/or the fluid supply system 130 may be initialized to supply working fluid to the bearing assembly 150, to discharge working fluid from the radial bearings 152, and to impinge the working fluid (e.g., vapor working fluid) against the shaft 104. In this way, the fluid supply system 130 and the bearing assembly 150 may cause the shaft 104 to lift from the radial bearings 152 and levitate within the bearing assembly 150 prior to rotation of the shaft 104 (e.g., prior to operation of the compressor 32).

Thereafter, operation of the compressor 32 may be initiated. However, it is desirable to confirm that the shaft 104 is not in contact with any of the radial bearings 152 (e.g., the pad portions 156) after operation of the bearing system 100 and/or the fluid supply system 130 is initialized and before operation of the compressor 32 is initialized. As another example, in some instances, the shaft 104 may contact one or more of the radial bearings 152 during operation of the compressor 32. For instance, one or more components of the compressor 32 may not operate as intended and/or operating conditions of the compressor 32 may cause one or more of the radial bearings 152 to contact the shaft 104. In some cases, debris or other elements may be introduced or released within the compressor 32 and/or the motor 50, which may cause undesired contact between the radial bearings 152 and the shaft 104. In any case, it is desirable to detect contact between the radial bearings 152 (e.g., bearing assembly 150, pad portions 156) and the shaft 104 to evaluate operation of the bearing system 100 and/or the compressor 32 and to enable proper operation of the bearing system 100 with the compressor 32.

Accordingly, the bearing system 100 (e.g., the controller 250) is configured to detect contact between the radial bearing 152 and the shaft 104. As discussed above, components of the radial bearing 152 (e.g., bearing assembly 150) may be formed from a metallic material, such as carbon, graphite, a metallic composite, a composite matrix material, sintered metal, or other suitable material (e.g., an electrically-conductive material). In particular, the base portion 154 and/or the pad portion 156 of the radial bearing 152 may be formed from a metallic material. The bearing housing 132 (e.g., casing 304) may also be formed from a metallic material (e.g., steel). Therefore, one or more components of the bearing assembly 150 may be formed from electrically-conductive materials. The shaft 104 of the compressor 32 may also be formed from a metallic material (e.g., steel). In order to detect contact between the radial bearing 152 and the shaft 104, the bearing system 100 (e.g., controller 250) is configured to detect and/or measure electrical continuity and discontinuity (e.g., electrical resistance) between the radial bearing 152 and the shaft 104. For example, the controller 250 of the bearing system 100 may be electrically coupled to the shaft 104 and may be electrically coupled to each radial bearing 152 (e.g., the bearing housing 132) of the bearing assembly 150. Thus, when one or more of the radial bearings 152 is in contact with the shaft 104, as in the first configuration 300 (e.g., contact configuration) shown in FIG. 10, the controller 250 may detect electrical continuity and/or reduced electrical resistance between the radial bearing 152 and the shaft 104 (e.g., via a flow of current supplied to the shaft 104 and/or the bearing assembly 150 by the controller 250). On the other hand, when the radial bearing 152 is in not contact with the shaft 104, as in the second configuration 302 (e.g., non-contact configuration) shown in FIG. 11, the controller 250 may detect electrical discontinuity and/or increased electrical resistance between the radial bearing 152 and the shaft 104. In this way, contact and non-contact between the radial bearing 152 and the shaft 104 may be detected by the bearing system 100.

In some embodiments, the bearing system 100 may be configured to establish and/or detect electrical continuity and discontinuity between the radial bearing 152 and the shaft 104 via electrical current directed through the materials (e.g., metallic materials, base materials) utilized form the components of the radial bearing 152 (e.g., bearing assembly 150). In other embodiments, the radial bearing 152 may include additional elements, such as electrical contacts 306, coupled to and/or embedded within the radial bearing 152 (e.g., the pad portion 156, base portion 154, and/or bearing housing 132) and/or within the shaft 104. The incorporation of electrical contacts 306 with enhanced electrical conductivity may improve and/or enable more reliable detection of electrical continuity and discontinuity between the radial bearing 152 and the shaft 104 to determine whether the shaft 104 is in contact with the radial bearing 152.

The bearing system 100 and/or compressor 32 (e.g., motor 50) may include additional or alternative features to enable detection of contact between the shaft 104 and the radial bearing 152 via the electrical continuity and discontinuity techniques described herein. For example, in some embodiments, the shaft 104 may include electrically conductive features, such as metallic bristles 308 (e.g., a brush, carbon brush) positioned on an outer diameter of the shaft 104. The metallic bristles 308 of the shaft 104 may contact the radial bearing 152 to establish electrical continuity between the shaft 104 and the radial bearing 152 to indicate contact therebetween. When the shaft 104 is properly lifted from the radial bearing 152 (e.g., via discharge of pressurized fluid toward the shaft 104 from the bearing assembly 150) and is not in contact with the radial bearing 152, the metallic bristles 308 may not contact the radial bearing 152, which may reduce or eliminate the electrical continuity therebetween (e.g., indicate electrical discontinuity therebetween) to indicate separation of the radial bearing 152 from the shaft 104 and thereby indicate desired levitation of the shaft 104 from the radial bearing 152.

Based on detections of electrical continuity and discontinuity and/or electrical resistances between the shaft 104 and the radial bearing 152, operation of the compressor 32 may be adjusted or controlled. For example, prior to startup of the compressor 32, the bearing system 100 and the fluid supply system 130 may be operated to direct working fluid through the fluid supply system 130 to the bearing assemblies 150 and to lift the shaft 104 from the bearing assemblies 150 so that the shaft 104 floats within the bearing assemblies 150 (e.g., without contact between the shaft 104 and the radial bearings 152). However, if the bearing system 100 (e.g., controller 250) detects electrical continuity between the shaft 104 and one or more of the radial bearings 152, a fault may be triggered (e.g., by the controller 250) to indicate that operation of the compressor 32 should not be initiated. If, during operation of the compressor 32, the bearing system 100 detects an electrical continuity between the shaft 104 and one or more of the radial bearings 152, another fault may be triggered (e.g., by the controller 250) indicative of contact between the shaft 104 and the bearing assembly 150. In such instances, for example, the compressor 32 may be shut down to enable rectification of the contact between shaft 104 and the bearing assembly 150. Further, each radial bearing 152 in the bearing assembly 150 may be separately monitored by the controller 250 to detect electrical continuity between the shaft 104 and the respective radial bearing 152. In some cases, sequential detection of contact between the shaft 104 and one or more of the radial bearings 152 of the bearing assembly 150 (e.g., in sequence about a circumference of the shaft 104) may be indicative of metallic debris orbiting about the shaft 104 between the bearing assembly 150 and the shaft 104, which may prompt shutdown of the compressor 32 (e.g., via the controller 250).

In addition to directing a current or voltage through the radial bearing 152 and/or the shaft 104 to determine electrical continuity or discontinuity (e.g., contact) between the radial bearing 152 and the shaft 104, a current or voltage may be directed through one or more of the radial bearings 152 (e.g., the bearing assembly 150) to determine an amount by which the radial bearings 152 are separated from the shaft 104 (e.g., fly height, lift height). In particular, an electrical conductivity or resistivity value of the working fluid discharged from the radial bearings 152 toward the shaft 104 may be a known value (e.g., stored in the memory device 254). Based on the known conductivity or resistivity value of the working fluid, a magnitude of a distance from the shaft 104 to one or more of the radial bearings 152 may be calculated (e.g., by the controller 250). Based on the calculated distance(s) between the shaft 104 and one or more of the radial bearings 152, operation of the compressor 32 and/or the bearing system 100 (e.g., the fluid supply system 130, the pump 206) may be adjusted.

In some embodiments, the bearing assembly 150 and/or the shaft 104 may include additional or alternative components configured to enable detection of contact between the bearing assembly 150 and the shaft 104. For example, the bearing assembly 150 and/or the shaft 104 may include one or more of the sensors 256 configured to detect an operating parameter indicative of contact between the shaft 104 and one or more of the radial bearings 152. The one or more sensors 256 may include proximity sensors, temperature sensors, voltage sensors, current sensors, and/or other types of sensors. In an embodiment of the radial bearing 152 having a temperature sensor, an increase in detected temperature may be indicative of increased friction and therefore contact between the radial bearing 152 and the shaft 104.

The radial bearing 152 illustrated in FIGS. 10 and 11 also includes damping elements 320. One or more damping elements 320 may be disposed between the radial bearing 152 (e.g., the base portion 154) and the bearing housing 132 and/or between the bearing housing 132 and the casing 304. The damping elements 320 may be configured to reduce vibration of the radial bearings 152 and/or shaft 104. Additionally or alternatively, the damping elements 320 may be configured to adjust a frequency of vibrations induced in the radial bearings 152 and/or the shaft 104. The damping elements 320 may have any suitable shape, geometry, composition, size, stiffness, and/or other characteristic to enable desirable tuning of the bearing assemblies 150. In some embodiments, the damping elements 320 may be O-rings, elastomeric seals, polytetrafluoroethylene (PTFE) rings (e.g., C-rings, spring-energized C-rings), Teflon, coil springs, squeeze film dampers, or any combination thereof. In an embodiment of the bearing assembly 150 having a squeeze film damper as one or more of the damping elements 320, damping provided by the squeeze film damper may be adjusted (e.g., via live fluid feedback dampers). It should be appreciated that the features described above with reference to the radial bearings 152 may be similarly incorporated with axial bearings.

As described in detail above, present embodiments are directed to a bearing system configured to enable and facilitate operation of a compressor in a vapor compression system with improved efficiency and at reduced costs. In particular, bearing systems described herein are configured to utilize a pressurized fluid, such as the working fluid (e.g., refrigerant) circulated through the vapor compression system, to support a load of the shaft of the compressor and enable rotation of the shaft within the housing of the compressor. The pressurized fluid may also function as a lubricant. To this end, the bearing system includes one or more bearings having porous bearing elements configured to receive the pressurized fluid. The pressurized fluid (e.g., liquid) may be directed through the porous bearing elements to contact the shaft within the housing of the compressor. As the pressurized fluid is directed through and discharged from the porous bearing elements, the pressurized fluid may vaporize or “flash” to become a vapor or gas that contacts the shaft and forms a hydrostatic film about the shaft. In this way, the working fluid circulated through the vapor compression system to enable heat exchange with other fluids (e.g., a conditioning fluid supplied to a load) may also be utilized as a lubricant that enables desired operation of the compressor. Indeed, present embodiments enable incorporation of bearings within the compressor without utilizing a separate, dedicated lubricant, such as oil. The disclosed bearing systems may also be implemented at reduced costs (e.g., manufacturing costs, operating costs, maintenance costs) compared to traditional bearings. Further, the techniques discussed herein enable incorporation and operation of bearing systems with compressors with simplified control schemes, improved reliability, and desirable monitoring.

While only certain features and embodiments have been illustrated and described, many modifications and changes may occur to those skilled in the art, such as variations in sizes, dimensions, structures, shapes and proportions of the various elements, values of parameters, such as temperatures and pressures, mounting arrangements, use of materials, colors, orientations, and so forth, without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the disclosure.

Furthermore, in an effort to provide a concise description of the exemplary embodiments, all features of an actual implementation may not have been described, such as those unrelated to the presently contemplated best mode, or those unrelated to enablement. It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A heating, ventilation, air conditioning, and refrigeration (HVAC&R) system, comprising:
a compressor configured to circulate a working fluid along a working fluid circuit;
a bearing disposed about a shaft of the compressor; and
a fluid supply system configured to direct a portion of the working fluid from the working fluid circuit to the bearing,
wherein the bearing is configured to discharge the portion of the working fluid toward the shaft.

2. The HVAC&R system of claim 1, wherein the fluid supply system is configured to supply the portion of the working fluid to the bearing in a liquid phase, and the bearing is configured to discharge the portion of the working fluid toward the shaft in a vapor phase.

3. The HVAC&R system of claim 2, wherein the bearing comprises a porous material, and the bearing is configured to direct the portion of the working fluid through the porous material to vaporize the portion of the working fluid discharged toward the shaft.

4. The HVAC&R system of claim 1, wherein the fluid supply system comprises a lubricant circuit extending from the working fluid circuit to the compressor, the lubricant circuit is configured to receive the portion of the working fluid from a liquid line portion of the working fluid circuit extending from a condenser of the working fluid circuit.

5. The HVAC&R system of claim 4, wherein the fluid supply system comprises a linear piston pump disposed along the lubricant circuit.

6. The HVAC&R system of claim 5, wherein the fluid supply system comprises a heat exchanger disposed along the lubricant circuit upstream of the linear piston pump relative to a flow direction of the portion of the working fluid along the lubricant circuit, wherein the heat exchanger is configured to place the portion of the working fluid in a heat exchange relationship with a cooling fluid to transfer heat from the portion of the working fluid to the cooling fluid.

7. The HVAC&R system of claim 5, wherein the fluid supply system comprises a pressure accumulator fluidly coupled to the lubricant circuit downstream of the linear piston pump relative to a flow direction of the portion of the working fluid along the lubricant circuit, wherein the pressure accumulator is configured to receive and contain an amount of the portion of the working fluid from the lubricant circuit.

8. The HVAC&R system of claim 5, wherein the fluid supply system comprises a differential pressure switch fluidly coupled to the lubricant circuit downstream of the linear piston pump relative to a flow direction of the portion of the working fluid along the lubricant circuit and fluidly coupled to an interior of a housing of the compressor, wherein the differential pressure switch is configured to actuate in response to a differential pressure between the lubricant circuit downstream of the linear piston pump and the interior of the housing being below a differential pressure threshold value.

9. The HVAC&R system of claim 8, comprising a controller communicatively coupled to the differential pressure switch, wherein the controller is configured to suspend operation of the compressor in response to actuation of the differential pressure switch.

10. The HVAC&R system of claim 1, comprising the shaft and a controller electrically coupled to the shaft and to the bearing, wherein the shaft comprises a first electrically conductive material, the bearing comprises a second electrically conductive material, and the controller is configured to detect contact between the shaft and the bearing based on a detected electrical continuity between the shaft and the bearing.

11. The HVAC&R system of claim 10, wherein the controller is configured to:
operate the fluid supply system to direct the portion of the working fluid from the working fluid circuit to the bearing;
detect separation of the shaft from the bearing based on a detected electrical discontinuity between the shaft; and
initialize operation of the compressor to rotate the shaft in response to detected separation of the shaft from the bearing.

12. A heating, ventilation, air conditioning, and refrigeration (HVAC&R) system, comprising:
a working fluid circuit comprising a compressor, an evaporator, and a condenser, wherein the compressor is configured to circulate a working fluid along the working fluid circuit;
a bearing assembly of the compressor, wherein the bearing assembly is disposed about a shaft of the compressor, the bearing assembly comprises a plurality of radial bearing segments arrayed about a circumference of the shaft, and each radial bearing segment of the plurality of radial bearing segments comprises a porous material; and
a fluid supply circuit extending from the working fluid circuit to the bearing assembly, wherein the fluid supply circuit is configured to direct a flow of the working fluid from the working fluid circuit to the bearing assembly.

13. The HVAC&R system of claim 12, wherein a radial bearing segment of the plurality of radial bearing segments is configured to receive a portion of the flow of the working fluid via the fluid supply circuit, to direct the portion of the flow of the working fluid through the porous material of the radial bearing segment, and to discharge the portion of the flow of the working fluid toward the shaft.

14. The HVAC&R system of claim 13, wherein the fluid supply circuit is configured to direct the flow of the working fluid from the working fluid circuit to the bearing assembly in a liquid phase, and the porous material of the radial bearing segment is configured to vaporize the portion of the flow of the working fluid to discharge the portion of the flow of the working fluid toward the shaft in a vapor phase.

15. The HVAC&R system of claim 13, wherein the radial bearing segment of the plurality of radial bearing segments comprises:
a base portion defining a cavity configured to receive the portion of the flow of the working fluid via the fluid supply circuit; and
a pad portion coupled to the base portion, wherein the pad portion comprises the porous material, and the pad portion is configured to direct the portion of the flow of the working fluid from the cavity to the shaft.

16. The HVAC&R system of claim 12, wherein the porous material is an electrically-conductive material comprising carbon, graphite, a composite matrix material, a sintered metal, or a combination thereof.

17. The HVAC&R system of claim 12, wherein the working fluid circuit comprises a liquid line portion extending from the condenser and configured to receive liquid working fluid from the condenser, and the fluid supply circuit extends from the liquid line portion to the bearing assembly.

18. A heating, ventilation, air conditioning, and refrigeration (HVAC&R) system, comprising:
a bearing configured to be disposed about a shaft of a compressor, wherein the bearing comprises a porous material, and the bearing is configured to discharge a flow of fluid through the porous material and toward the shaft of the compressor; and
a fluid supply system configured to direct the flow of fluid from a working fluid circuit of the HVAC&R system to the bearing,
wherein the fluid supply system is configured to supply the flow of fluid to the bearing in a liquid phase, and the bearing is configured to discharge the flow of fluid toward the shaft in a vapor phase.

19. The HVAC&R system of claim 18, comprising the working fluid circuit, wherein the compressor is disposed along the working fluid circuit and is configured to direct a working fluid along the working fluid circuit, the fluid supply system comprises a fluid supply circuit extending from the working fluid circuit to the bearing, and the fluid supply circuit is configured to direct a portion of the working fluid from the working fluid circuit to the bearing as the flow of fluid.

20. The HVAC&R system of claim 19, comprising:
a heat exchanger disposed along the fluid supply circuit, wherein the heat exchanger is configured to transfer heat from the portion of the working fluid to a cooling fluid; and
a pump disposed along the fluid supply circuit downstream of the heat exchanger relative to a flow direction of the portion of the working fluid along the fluid supply circuit, wherein the pump is configured to direct the portion of the working fluid to the bearing.
